(19) United States
(12) Patent Application Publication
(10) Pub. No.: US 2002/0055574 A1
(43) Pub. Date: May 9, 2002

(54) Use of a modified polypropylene compound for the production of attachments in the automobile industry

(76) Inventors: Theodor Uhlenbroich, Duisburg (DE); Dietmar Borg, Monheim (DE)

Correspondence Address: FULBRIGHT & JAWORSKI, LLP, 666 FIFTH AVE, NEW YORK, NY, 10103-3198, US

(21) Appl. No.: 09/851,366

(22) Filed: May 8, 2001

(30) Foreign Application Priority Data
May 24, 2000 (DE) 100 25 427.6

(51) Int. Cl. C08K 3/30; C08K 3/34

(52) U.S. Cl. 524/423; 524/451

(57) ABSTRACT

The use of polypropylene or a polypropylene compound, which contains 5 to 30% by weight (relative to the finished compound) of barium sulphate with an average particle size of 0.5 to 5 μm and 0.5 to 3% by weight (relative to the finished compound) of talc with an average particle size of 0.5 to 5 μm, is described for the production of automobile attachments, such as, for example, bumpers.

The invention relates to the use of a modified polypropylene compound for the production of attachments in the automobile industry.

Polypropylene compounds (PP-compounds) which are modified by one or more elastomers, such as ethylene-propylene-diene and polymethylene (EPDM) or styrene-acrylonitrile-copolymers (SAN), are used in the production of attachments (for example fenders or mud-guards) in the automobile industry. The elastomers that are used give rise to a higher impact resistance and low-temperature impact resistance in comparison with PP-compounds that are not modified by an elastomer or elastomers, that is, are not elastomer-modified. The disadvantages inter alia are the negative effects upon the thermal dimensional stability (Vicat-temperature) and the surface hardness of the elastomer-modified PP-compounds and the comparatively high price of the elastomers mentioned.

The object of the invention is to set forth a way of producing from PP-compounds attachments that have an increased thermal dimensional stability (Vicat-temperature) and an increased surface hardness for the automobile industry without using comparatively expensive elastomers, such as EPDM or SAN, in which case the properties of the PP-compounds used in accordance with the invention, such as, for example, impact resistance, low-temperature impact resistance, modulus of elasticity and lacquer adhesion, are to correspond to those properties of the elastomer-modified PP-compounds currently used or at the very best are to be further improved.

The object is achieved by means of the use of polypropylene or a polypropylene compound, which has been modified as a result of the addition of 5 to 30% by weight (relative to the finished compound) of barium sulphate with an average particle size of 0.5 to 5 μm and as a result of the addition of 0.5 to 3% by weight (relative to the finished compound) of talc with an average particle size of 0.5 to 5 μm, for the production of automobile attachments.

It has been found that the modified PP-compound which is used in accordance with the invention has a comparatively high thermal dimensional stability and a comparatively high surface hardness and therewith improved lacquer adhesion, given properties that are otherwise comparable with PP-compounds conventionally used. A further advantage of the PP-compound used in accordance with the invention is that it does not contain an expensive elastomer.

The polypropylenes that are usually used for the production of attachments are used as the polypropylene. A commercially available easy flowing polypropylene homopolymer or polypropylene copolymer with a melt index MFR according to DIN ISO 1133 of at least 10 g/10 min can be used for example.

If an increase in the density of the PP-compound conditional on the addition of BaSO₄ is less desirable, the quantity of barium sulphate added preferably amounts to 5 to 20% by weight.

The average particle size of the barium sulphate preferably amounts to 2 to 4 μm.

The average particle size of the talc preferably amounts to 1 to 3 μm.

The PP-compound used in accordance with the invention can also still contain further common auxiliary and additional substances, such as, for example, polyethylene, pigments (carbon black) or stabilizers. Standard antioxidants, for example sterically hindered phenols or sterically hindered triaryl phosphites, can be used as the stabilizers.

Attachments for the automobile industry are produced in a known manner from the PP-compound used in accordance with the invention.

The subject of the invention is explained in greater detail with reference to the following examples.

### EXAMPLES 1 TO 3 IN ACCORDANCE WITH THE INVENTION AND COMPARISON EXAMPLES A AND B

The modified PP-compounds specified in Table 1 were produced by pre-mixing the components and subsequently carrying out double extrusion in a double screw extruder (Leistritz). The speed amounted to approximately 30 revolutions per minute and the temperature in all the zones amounted to approximately 200° C.

TABLE 1
Recipes for the PP-compounds used in
accordance with the invention (numerical data in g):

| | | | | Poly- |
|---|---|---|---|---|
| | PP- | Barium | | ethylene |
| Example | compound¹⁾ | sulphate²⁾ | Talc³⁾ | LD 1922⁴⁾ |
| 1 | 1360 | 400 | 40 | 200 |
| 2 | 1760 | 220 | 20 | |
| 3 | 1760 | 210 | 30 | |

¹⁾PP Block-copolymer StamylanP PHC27 ex DSM, MRF = 14 g/10 min
²⁾Barium sulphate blanc fixe N ex Sachtleben Chemie, d 50 = ca. 3 μm
³⁾Ground talc Fintalk M 05 ex Finminerals, d 50 = ca. 2.3 μm
⁴⁾Low Density Polyethylene 1922 T ex DSM, density 919 kg/m3, MFI (190° C. and 5 kg) 75 dg/min, Shore D 45

The properties impact resistance and cold impact resistance were determined according to DIN EN ISO 179, the maximum flexural strain and the modulus of flexural elasticity were determined according to EN ISO 178, the Vicat-temperature B/50 was determined according to DIN EN ISO and the melt index (MFR) was determined according to DIN ISO 1133.

In order to determine the cold impact resistance, test bodies without notches (standard bar according to DIN 53453) were produced from a portion of the extruded mixture and, before determining the cold impact resistance, were dipped into liquid nitrogen. In order to determine the cold impact resistance, the test bodies were removed from the nitrogen, kept at room temperature for 1 minute and subsequently battered, the test bodies being at a temperature of approximately −50° C.

The results of the measurements are set out in Table 2.

TABLE 2
Properties of the PP-compounds used in
accordance with the invention (Examples 1 to 3) and
elastomer-modified compounds (Comparison Examples A and B):

| | | Cold | | | | | |
|---|---|---|---|---|---|---|---|
| | | impact | | Mod. of | | | |
| | Impact | resist- | Max. | flexural | | | |
| | resist- | ance | flexural | elast- | MFR | Vicat | Shore D |
| | ance (mJ/ | (mJ/ | strain | icity | (g/10 | temp. | hardness |
| Example | mm²) | mm²) | (N/ mm²) | (N/ mm²) | min) | B/50 (° C.) | (N/ mm²) |
| 1 | Without | 18.6 | 27.9 | 1219 | 13.2 | 58 | 63 |
| | fracture | | | | | | |
| 2 | Without | 19.3 | 28.8 | 1102 | 14.9 | 62 | 66 |
| | fracture | | | | | | |
| 3 | Without | 25.3 | 27.3 | 1125 | 16 | 62 | 64 |
| | fracture | | | | | | |
| A¹⁾ | Without | 22.6 | 21.1 | 1136 | 13 | 38 | 55 |
| | fracture | | | | | | |
| B²⁾ | Without | 25.4 | 27.0 | 1360 | 15.6 | 43 | 50 |
| | fracture | | | | | | |

¹⁾ Keltan 2500/2 ex DSM
²⁾ Keltan 2550/1 ex DSM

For comparison purposes, the corresponding measured values of conventional elastomer-modified PP-compounds (Keltan 2500/2 and Keltan TP 2550/1 ex DSM) are set out in Comparison Examples A and B.

It is evident from the measurement results that the PP-compounds that are used in accordance with the invention and which advantageously do not contain an elastomer substantially correspond to the elastomer-modified PP-compounds with regard to the properties impact resistance, cold impact resistance, maximum flexural strain, modulus of flexural elasticity and melt index. The thermal dimensional stability, of which the Vicat-temperature is a measure, is clearly increased. The Shore-D-hardness is also advantageously increased with the use in accordance with the invention of the PP-compounds modified by barium sulphate and talc.

### EXAMPLE 4

Larger quantities of PP-compounds were produced in accordance with Examples 1 to 3 and these were subsequently granulated. Attachments, in this case automobile bumpers, were produced from these granules using the known injection-moulding process. For this the granulated material (moulding material) was fed by way of a funnel to a rotating and heated screw. The moulding material was conveyed to the screw tip and thereby melted down as a result of thermal conduction and friction. When the moulding material had melted down sufficiently, the screw rotation was stopped and the melt pressed into a tempered mould in order to produce bumpers. The bumper thus produced (injected article) was removed from the opened mould.

On account of the increased surface hardness, when the bumpers were removed there were no signs of handling equipment.

In practical tests, attachments produced with the PP-compound used in accordance with the invention had better lacquer adhesion than attachments produced with an elastomer-modified PP-compound, something which can be attributed to the increased surface hardness.

1. Use of polypropylene or a polypropylene compound which contains 5 to 30% by weight (relative to the finished compound) of barium sulphate with an average particle size of 0.5 to 5 μm and 0.5 to 3% by weight (relative to the finished compound) of talc with an average particle size of 0.5 to 5 μm, for the production of automobile attachments.

2. Use according to claim 1, characterized in that the quantity of barium sulphate added amounts to 5 to 20% by weight.

3. Use according to claim 1 or 2, characterized in that the average particle size of the barium sulphate amounts to 2 to 4 μm.

4. Use according to one of claims 1 to 3, characterized in that the average particle size of the talc amounts to 1 to 3 μm.
